(19) United States
(12) Patent Application Publication
(10) Pub. No.: US 2009/0166429 A1
(43) Pub. Date: Jul. 2, 2009

(54) Articles Incorporating Electronic Signalling Devices

(75) Inventor: Peter Roger Aylmore, Surrey (GB)

Correspondence Address: YOUNG & THOMPSON, 209 Madison Street, Suite 500, ALEXANDRIA, VA, 22314, US

(73) Assignee: Environmental Polymer Technologies Limited, Surrey (GB)

(21) Appl. No.: 11/921,467

(22) PCT Filed: Apr. 26, 2006
(86) PCT No.: PCT/GB2006/001541

§ 371 Date: Aug. 27, 2008

(30) Foreign Application Priority Data
Apr. 26, 2005 (GB) 0508396.9

(51) Int. Cl. G06K 19/02; B29C 67/20

(52) U.S. Cl. 235/488; 264/46.4; 340/572.8

(57) ABSTRACT

An article comprises an electronic signalling device embedded in a foamed plastics material e.g. plastics material, to allow one or more of location, identification, tracking etc. of the article. The embedding provides thermal and mechanical protection and can be used to conceal the device from external view and/or surreptitious removal.

This invention relates to articles which incorporate electronic signalling devices and, in particular but not exclusively, to transit or location articles which accompany items in transit or location or in storage whether for e.g. retail distribution or for storage and transit of components in an assembly line. Typical examples of transit or location articles within the context of this specification are pallets, boxes and other containers; other articles of interest are articles formed wholly or partially of plastics whose location or identity is to be checked.

It has been proposed to associate some form of electronic signalling device with containers so as to signal their presence either actively or passively when interrogated by a suitable electronic signal. This form of electronic tagging can be for many different applications, for example security against theft, logging progress through an assembly line, locating the whereabouts of a container within a storage area, identifying the contents thereof and so on. We have found however that there are practical difficulties with such arrangements because, if the electronic device is externally visible or accessible, it may be prone to damage or illegitimate removal from the container and, being visible alerts an observer to its presence. In addition, the device can be prone to physical or other damage, either during the manufacturing process or later.

There has been a proposal to fit a signalling device within a recess in a moulded plastics container but this does not provide a high level of security. It has also been proposed to position a radio frequency identification device (RFID) against the wall of an injection mould prior to admission into the mould of the injection plastics material. In this instance, the RFID is mounted at the surface of the injection moulded article and so is prone to damage/illegitimate removal, and also potentially to heat damage due to being located next to the metal surface of the mould. US 2004/0238623 discloses such an arrangement.

Accordingly, in one aspect, this invention provides an article comprising:—

a body portion at least part of the thickness of which is of foamed plastics material, and

an electronic signalling device integrally embedded in said foamed plastic material.

This arrangement has several advantages over those described above; embedding the electronic signalling device within the foamed plastics material renders it more resistant to illegitimate removal; embedding in foamed material provides good anti-shock and thermal insulating properties; in many applications embedding of the electronic signalling device in the foamed plastic material will render it invisible to external view and so someone illegitimately moving or handling the article will not know whether it contains an electronic signalling device and if so where that device is located; furthermore, even if the device is located its removal will require major disruption of the body thereby making the installation tamper evident.

Preferably, the external surface of the formed article is substantially continuous and uninterrupted in the region adjacent the electronic signalling device. In this arrangement the presence of the radio signalling device is obscured in applications where the core material and/or the skin material are opaque. Also it cannot be prised free of the article without removing a section of the surface of the article and thereby leaving evidence of the tampering. In arrangements as seen in US 2004/0238623, the presence of the RFID on the surface of the product means that it can be prised out with minimal or no disruption of the surrounding area.

In one embodiment, the body region is made up of a core of said foamed plastics material with a skin element on one or both sides thereof. This construction is light and stiff and the skin elements provide abrasion and weather protection for the foamed plastics material. In one arrangement the spaced skin elements are integrally bonded to either side of said core. In a particularly preferred element, the body is made using a powder impression moulding process of the type set forth in WO02/062550.

The electronic signalling device may be a passive device which responds to a suitable interrogation signal which provides the power necessary for the device to return a response signal, but it may instead be active in terms of having its own power supply attached thereto. The design, construction and utilisation of such device is well known to those skilled in the art. Thus the electronic signalling device may be an RFID device or it could comprise a communication module capable of communicating by radio with an external network such as the mobile telephone communications network or a locally set up radio network using e.g. short range radar links such as Bluetooth or DECT etc.

The article may take the form of a transit or location article such as a pallet, a container for shipment of retail goods and/or foodstuffs, or a container for transport of other goods. Alternatively the article may be any outer type of article whose location, presence or identity is to be checked. Examples include boats, surfboards, road traffic cones, road barrier components to name but a few.

In another aspect, this invention provides a method of producing an article, which method comprises the steps of:—

providing at least one mould portion having wall means defining a mould cavity to form a body portion of said article;

locating in said cavity an electronic signalling device spaced from the wall means, and

introducing a foamed or foamable plastics material into said cavity thereby to form a transit or location article having a body portion in which the electronic signalling device is integrally embedded in said foamed plastics material and spaced from the surface thereof.

In one preferred arrangement two complementary mould portions are provided to define said mould cavity.

In one embodiment, the method includes the step of heating the complementary mould portions, applying a plastics particulate material to said heated mould portions so as to soften to form a skin after which said electronic signalling device is located adjacent, or spaced interiorly of, one of said skins, a foamable plastics material is applied to at least one of the exposed skins and the mould then closed to allow the plastics material to foam and embed said electronic signalling device.

In another aspect the invention also extends to an article of plastics material having a body portion in which an electronic signalling device is embedded and spaced from the surface or surfaces of the body portion.

Whilst the invention has been described above, it extends to any inventive combination of the features set out above or in the following description.

The invention may be performed in various ways and an embodiment thereof will now be described, by way of example only, reference being made to the accompanying drawings in which:—

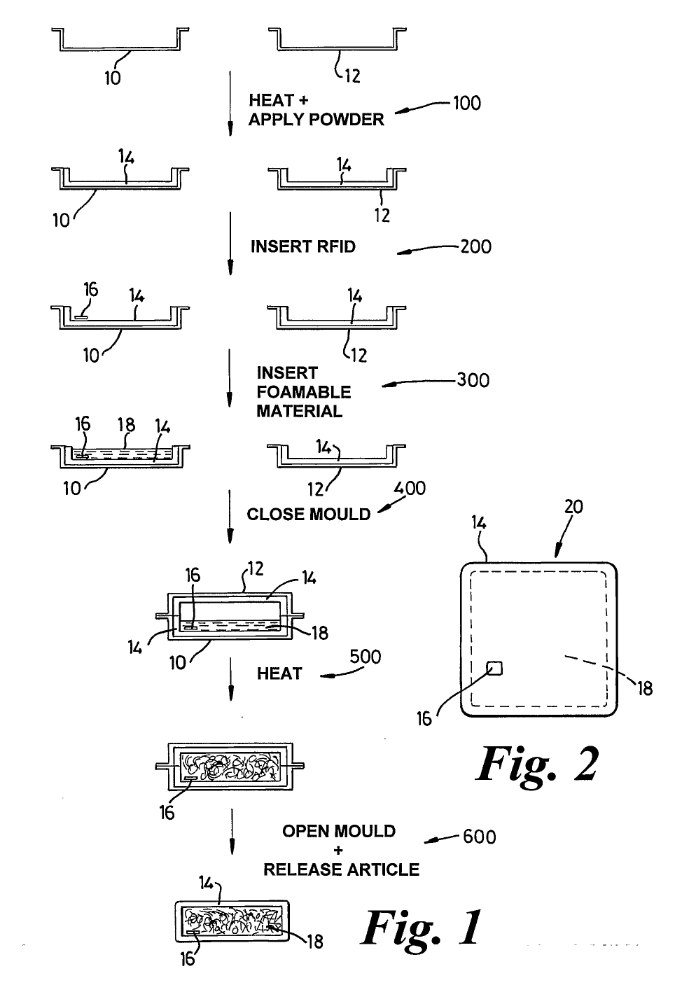

FIG. 1 is a schematic view of a method for producing an article in accordance with this invention, and

FIG. 2 is a top plan view of a formed article.

In this particular example a transit or location article is shown as a single panel having embedded therein an RFID device; it will of course be appreciated that the article may take many different forms such as transit or location articles e.g. pallets, containers etc., as well as more general articles whose location or identity is to be determined for inventory purposes.

In order to produce the transit or location article a power impression moulding process is used which makes use of complementary moulds 10 and 12 which are shown in this arrangement as being of thin walled form but may be of a much thicker cast and/or milled form in practice. Many of the steps in the process are similar to those of the powder impression moulding process described in WO02/062550, the entire contents of which are incorporated herein by reference.

Thus the complementary moulds are first heated so that when a particulate thermoplastic powder material is applied at step 100, it melts to form a thin skin 14 on each of the moulds. In the next stage, 200, a radio frequency identification device, RFID 16 is located in the required position on the skin in what will be the lowermost mould 10. At stage 300 a foamable plastics material 18 is loaded into the lower mould 10 on top of the RFID 16. It should be noted that, dependent on the desired position of the RFID 16 relative to the thickness of the device, it may be located on the skin material or in or on the layer of foamable plastics material added at stage 300.

The foamable material may comprise or contain recycled plastics material alone or mixed with other waste material. The foamable material 18 contains a foaming agent which is activated by heat. The mould is then closed, 400, by inverting the mould 12 and placing it in registration with the lower mould 10. Heat is then applied, 500, to activate the foaming agent so that the foamable material foams and expands to fill the entire cavity defined between the two skins 14 and bonding securely to each. The mould is then opened, 600, to release the article 20.

As seen in plan in FIG. 2, the finished product has the RFID 16 embedded in a foam core 18 which itself is encased in a plastics skin 14.

In the finished article, the foam material serves to protect the RFID against shock and tampering. Its location away from the mould surface means that it is protected against exposure to high or low temperature that would be the case should the device be in contact with the metal mould in e.g. an injection moulding process. Furthermore, the location of the RFID in the mould can be varied between subsequent items. In addition, in certain applications, more than one RFID may be located in the mould.

In another arrangement, not shown, the RFID may be located within a holder or capsule before it is inserted into the mould. The holder capsule may take many forms; it could be in the form e.g. of a plastics foamed capsule. Alternatively it could be a rigid holder. The capsule or holder may conveniently be designed to offer further thermal or vibration protection.

Although in the above example the article is made using thermoplastic materials, it should be appreciated that other embodiments may utilise thermosetting plastics material either in part or whole. Thus the foamed plastics material and/or one or both skins, where provided, may be of thermoset plastic material.

1-11. (canceled)

12. An article comprising: a body portion at least part of the thickness of which is of foamed plastics material, and an electronic signalling device embedded in said foamed plastics material.

13. An article according to claim 12, wherein said body region is made up of at least one skin element disposed to at least one side of a core of said foamed plastics material.

14. An article according to claim 13, wherein said body region is made up of spaced skin elements integrally provided to either side of said core.

15. An article according to claim 13, wherein said electronic signalling device is spaced away from said at least one skin element.

16. An article according to claim 12 wherein said body portion is formed wholly or partially of thermoplastics material.

17. An article according to claim 12 wherein said body portion is formed wholly or partially of thermosetting plastics material.

18. An article according to claim 12 including a plurality of electronic signalling devices integrally embedded in said foamed plastics material.

19. An article according to claim 12, wherein said body portion is made by a powder impression moulding process.

20. An article according to claim 12, adapted for use as a pallet.

21. An article according to claim 12, in the form of a container.

22. A method of producing an article, which method comprises the steps of:—providing at least one mould portion having wall means defining a mould cavity to form a body portion; locating in said cavity an electronic signalling device spaced from said wall means, and introducing a foamed or foamable plastics material into said cavity thereby to form an article having a body portion in which the electronic signalling device is embedded in said foamed plastics material.

23. A method according to claim 19, wherein two complementary mould portions are provided, and which includes the step of heating the complementary mould portions, applying a plastics particulate material to said heated mould portions so as to soften to form a skin after which said electronic signalling device is located on or spaced from the interior of one of said skins, a foamable plastics material is applied to at least one of the exposed skins and the mould then closed to allow the plastics material to foam and embed said electronic signalling device.

24. An article according to claim 14, wherein said electronic signalling device is spaced away from said at least one skin element.

25. An article according to claim 13, wherein said body portion is formed wholly or partially of thermoplastics material.

26. An article according to claim 14, wherein said body portion is formed wholly or partially of thermoplastics material.

27. An article according to claim 15, wherein said body portion is formed wholly or partially of thermoplastics material.

28. An article according to claim 13, wherein said body portion is formed wholly or partially of thermosetting plastics material.

29. An article according to claim 14, wherein said body portion is formed wholly or partially of thermosetting plastics material.

30. An article according to claim 15, wherein said body portion is formed wholly or partially of thermosetting plastics material.

31. An article according to claim 16, wherein said body portion is formed wholly or partially of thermosetting plastics material.
